(19) United States
(12) Patent Application Publication
(10) Pub. No.: US 2002/0049848 A1
(43) Pub. Date: Apr. 25, 2002

(54) Updatable digital media system and method of use thereof

(76) Inventors: Shaw-Yueh Lin, San Diego, CA (US); Szeying Tan, San Diego, CA (US)

Correspondence Address: DANIEL ROBBINS, 3346A INDUSTRIAL COURT, SAN DIEGO, CA, 92121, US

(21) Appl. No.: 09/878,520

(22) Filed: Jun. 11, 2001

Related U.S. Application Data
(60) Provisional application No. 60/211,117, filed on Jun. 12, 2000.

(51) Int. Cl. G06F 15/16

(52) U.S. Cl. 709/227; 709/219

(57) ABSTRACT

The invention anticipates the interests of the user and accordingly generates updated data. Updates are accurately inferred from the user's offline browsing pattern on a local CD or other digital media, and from online browsing of sites on the Internet. When the user is offline, a profiling program at the user's location tracks the CD or other digital media files accessed by the user, and stores this information in an addressable file of the user's computer. Correspondingly, when online, the user's server tracks and profiles the content of the web sites visited by the user. In both cases, the resultant profiles are available at the user's server, and by determination of the basic content that characterizes the accumulated data, the server derives a statistically based pattern of the user's current interest. The server retrieves relevant information based on this pattern, and accordingly updates the media.

This application claims the benefit of Provisional Application, Ser. No. 60/211,117 filed Jun. 12, 2000.

### BACKGROUND OF THE INVENTION

1. Field of the Invention

This invention relates to the formatting and storage on digital media of a digital file, and in particular, to the acquisition and updating of such digital file information transferred by means of a link such as the Internet.

2. Description Relative to the Prior Art

The proliferation of information via Internet web pages has generated interest in optimum formats for transferring information between a web page server and a remote user location. The remote user,having a programmed device such as a computer or palm top unit, establishes communication over the Internet with a selected web page server. The remote user may make a request, and the web page server then transfers back information from its stored files to the remote location in response to the request. Alternately, the web page server may query the remote location for more specific information when responding to a user request, such as, asking for the author of a book whose title was part of the user's request, or a request for shipping information; that is, information it needs but is not in its current files. Such communication is essentially bi-directional and “open ended” in that every action is a specific inquiry resulting in a specific response. Depending on who initiates the query, the information is stored either on the digital medium of the user or the web server, where it statically resides unchanged until a new round of questions and answers is initiated.

The previous scenario cannot be followed when a structural change is called for in program files or in information files in the end user's system when the need for the change is neither known nor anticipated by the user. These files may have previously been acquired from a digital media storage such as a CD ROM, magnetic medium, flash card and other pre-recorded storage media, or the files may have been downloaded through a link on the Internet and reside in on the hard disk of the user's computer. The fact that updating changes to the program or other information are required is generally unforeseeable by the user. It is known in the art that the information supplier may alert the end user by means of a message via the Internet that an update is required, and for the supplier to download the updated material to the user. This typically occurs, for example, in updating a browser program.

Alternately, the user may have information at his location stored on a medium that is not re-recordable, such as a CD ROM. U.S. Pat. No. 6,128,652 in the names of Toh et al, discloses updating information present on such a CD ROM wherein the server identifies the relevant files to be updated by means of a stored index, and transfers the new information to a tagged sector of the user's hard disk. This updated information is transparently accessed whenever the corresponding file on the CD is addressed by the user, and is retrievably stored on the user's hard disk. Interaction between the user and his server may be effected by hyperlink transfer, as is known in the art.

It will be noted the prior art discloses updates based on specific requests from a user, or by a determination by a server keeping track of information previously provided to the user that an update is due. These updates are conventionally triggered by the obsolescence of the data at the user's location, and the need to keep factual data current and correct.

The current invention broadens the criteria in determination of the initiation and content of updates, and and provides a simplified technique for implementing informational updates.

### SUMMARY OF THE INVENTION

Rather than relying on past information and past updates provided to a user in deciding whether a new update is required, the present invention discloses anticipating the interests of the user and dynamically providing updated data based on this determination. The interests of a user may be accurately inferred from the user's offline browsing pattern on a local CD or other digital media, and from online browsing of web sites of the Internet. In the practice of the invention, when the user is offline, a profiling program at the user's location tracks the CD or other digital media files accessed by the user, and stores this information in an addressable file of the user's computer. Correspondingly, when online, the user's web server tracks and profiles the content of the web sites visited by the user. In both cases, the resultant profiles are available at the user's server, and by determination of the basic content that characterises the accumulated data, the server derives a statistically based pattern of the user's current interest. Using this pattern as a template, the server generates an informational update reflecting the user's current interests, and this information is both stored at the server and transferred to the user's computer file. This dynamic updating is an ongoing process not requiring action or intervention by the user, and is located at the file address originally accessed by the user. It will be noted that the phrase “web server” broadly covers Internet network servers as well as local area network servers.

### BRIEF DESCRIPTION OF THE DRAWINGS

The invention will be described with respect to the drawings of which:

FIG. 1 is a schematic drawing of the interconnection between a user computer and a web server,

FIG. 2 is a schematic drawing of the file sectors of the units of FIG. 1, and

FIG. 3 is a flow diagram showing the steps in updating the digital information accessible by the user's computer.

### DESCRIPTION OF THE PREFERRED EMBODIMENTS

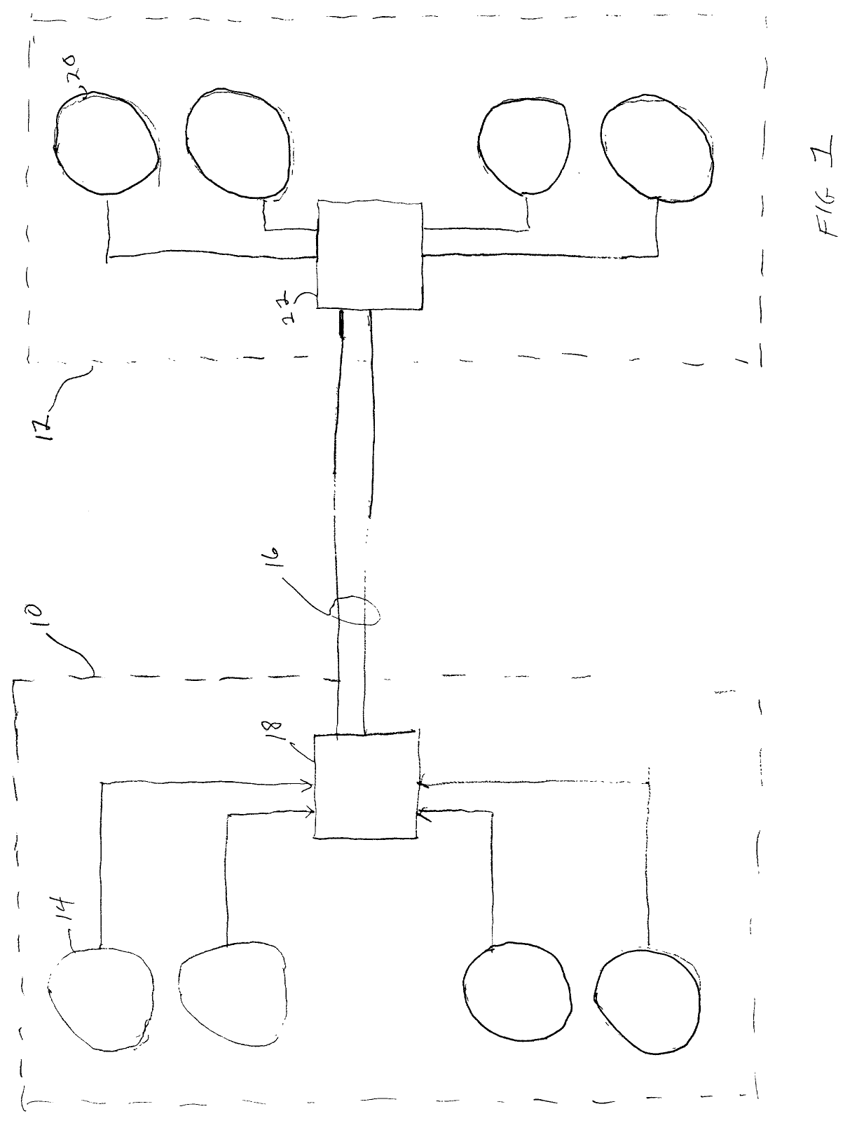

The media storage system of the invention is designated as the Updatable Digital Media System, with the acronymn UDMS. Referring to FIG. 1, the overall relationship between a user computer 10 and a cooperative web server 12 is illustrated. The computer 10, includes UDMS components, e.g. 14, that consists of specific sectors of the digital updatable media. These components, e.g. 14 are available to, and addressable by the user computer processor 18 which is also connectable to a link 16, such as the Internet. The web server 12, has stored in its UDMS corresponding file components e.g. 20, and communicates over the link 16 with the user computer 10 under control of the web processor 22.

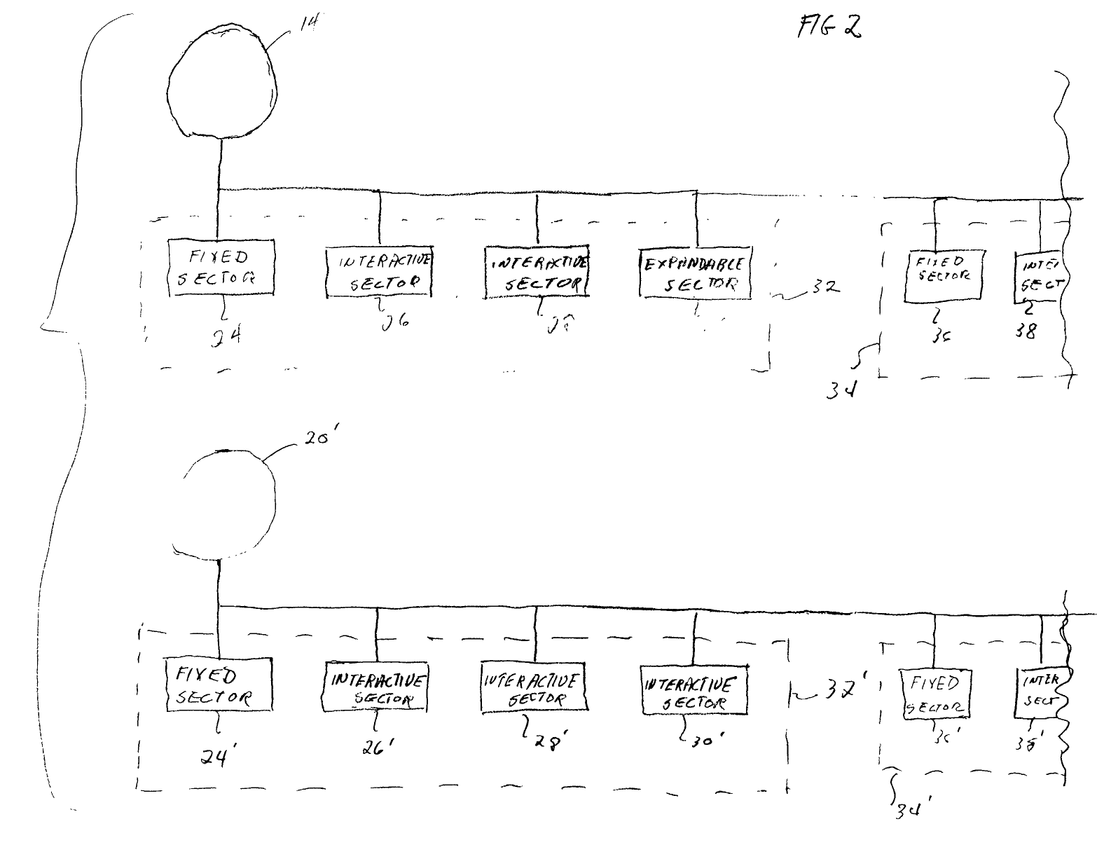

It will be noted that these file components, e.g. 14, are broadly defined and may consist of various sub files linked together and under control of the user's computer's core program. For example, file component 14 may incorporate text, picture, digital audio, video and graphic files. Referring to FIG. 2, a file component e.g. 14′ is seen to be composed of various files, e.g., 32,34, where file 32 in turn may have fixed sectors, e.g. 24, interactive sectors, e.g. 26,28 and expandable sectors,e.g. 30, and file 34 has fixed sectors, e.g. 36, interactive sectors, e.g. 38, and expandable sectors (not seen in the drawing). In the drawings, related elements are identified with the same reference characters, albeit that corresponding elements in the various drawings are distinguished by primes.

In FIG. 2, the corresponding UDMS component 20′ stored at the web server 12 is illustrated with the corresponding files e.g. 32′ and 34′. File 32′ having corresponding fixed sectors e.g. 24′, interactive file sectors 26′,28′ and expandable sectors, e.g. 30′, and file 34′ having fixed sectors e.g. 36′, interactive sectors, e.g. 38′ and expandable sectors (not seen in the drawing).

A file's fixed sector is designated as the default sector; that is, when files are loaded, the user's operating system goes to the first default file for instructions. Conventionally, the core program for the user's system may be recorded in such a fixed sector of a read-only digital medium, for example, a CD-ROM, and when this digital medium is activated in the user's computer, the default program is read from the medium to start computer operation. Initiation of the user's computer core program by this technique,(or by other start-up methods available to the user at his computer,) allows automatic implementation of updating the user's computer digital media in the following manner.

It is to be first noted, that the user's computer file structure will have been either downloaded from the server, or will have been read from digital media available at the web server. That is, the structure of the user's file system is available at the web server's database. To identify a given user site from others being serviced by the same web server, the UDMS system mandates assignment of a Unique Media Identifier (UMI) to each user location of the UDMS. The UMI always includes a unique identifier of the user, and a unique identifier of the version of the information stored on the media being updated, and may include additional fields of relevant information, such as, type of product or service associated with the media.

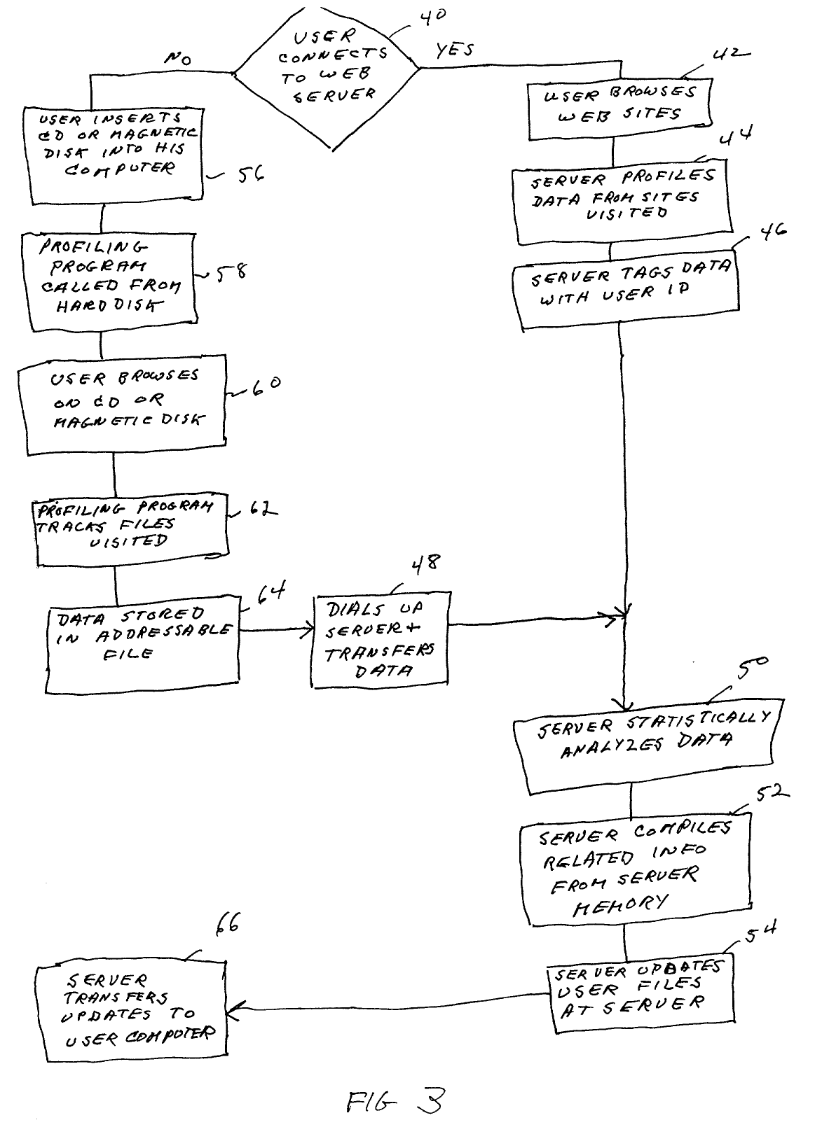

With the above described structural organization in mind, and referring to FIG. 3, the steps of updating a user's digital media is shown. Initially, a computer user 10 may decide 40 to either connect to the web or to browse on his digital media locally available. If the decision is to go to the web, the user browses 42 on various websites, depending upon his interests and the specific information he wants to gather. The server 12 collects data relative to the visited sites, profiles 44 and stores the data and the identification 44 (UMI) of the user computer 10. The web server 12, being connected to the user computer 10, also queries 48 whether there are sets of similar new data stored in the user computer derived from browsing the user/s computer digital media, as will be explained in detail below. If there is no new browsing data from the user computer 10, the server statistically analyzes 50 the data related to the web sites visited, and determines the overall broad content of the user's interests from the structure of the web sites visited. For example, if the user had browsed web sites related to travel, and viewed European cities, hotels, train schedules, the web server accesses it own information storage files, and organizes and puts together a packet of information on European restaurants, airline discounts, auto rental and other pertinent information. The web server itself is continually provided with the latest data related to the fields of interest of its clients in a wide variety of activities, such as, travel, sports, clothing, books, music and others developed in response to the clients' browsing habits. In the above example, the web server 12 then updates 54 a user travel-tagged file stored at the web server 12 that links to the next query the user makes to a travel related web site. This updated information is also transferred 66 to a tagged file on the user computer 10 hard disk. The user is thereby provided with updated travel information on an ongoing basis, and similarly for other areas of interest.

Referring again to FIG. 3, if the user does not log 40 onto the web, but instead browses the digital media of the user computer 10, he inserts 56 a pre-recorded information CD or media disk into the computer 10, or he links to information files on his hard disk. The user computer 10 defaults 58 to a profiling program such that as the user browses 60 on the digital media, data relating to the media files visited are profiled 62 and stored 64 in a local file. The profiling program then dials up 48 the web server 12 and transfers the data stored 64 to the web server 12. The web server 12 analyzes 50 the data transferred 48 from the user computer in exactly the same manner as previously described, and then transfers 66 the updated files to the user's computer for storage.

The updating of the files 66 on the user computer, and updating 54 at the web server also modifies the browsing programs addresses so that subsequent access to either the local digital media or to web sites on the Internet do not go to the original addresses, but are switched to the latest updated files either on user computer storage, or in the web server memory. In this way the latest statistically derived updates are transparently provided to the user.

The invention has been described in detail with particular reference to preferred embodiments thereof, but it will be understood that variations and modifications can be effected within the spirit and scope of the invention.

What is claimed is:

1. A method for updating information on a digital medium at a user computer, said method comprising the steps of:
a) accessing a plurality of network sites by said user computer,
b) browsing said plurality of network sites,
c) organizing a profile of commonly related contents of said plurality of sites,
d) storing said profile in a first addressable file of said user computer,
e) transferring the information of said first addressable file to a server,
f) statistically analyzing the data from said first addressable file by said server to provide links to related information stored at said server,
g) compiling by said server said related information into a second addressable file,
h) transferring by said server said related information from said second addressable file to said user computer,
i) updating said digital medium with said related information from said second addressable file.

2. The method of claim 1 wherein said updating is updating a computer disk (CD) at said user computer.

3. The method of claim 1 wherein said updating is updating an insertable magnetic disk at said user computer.

4. The method of claim 1 wherein said updating is updating a hard disk at said user computer.

5. The method of claim 1 wherein said updating further comprises updating a user identified file at said server.

6. A method for updating information on a digital medium at a user computer, said method comprising the steps of:
a) accessing a plurality of files from said digital media at said user computer,
b) browsing said plurality of files,
c) organizing a profile of commonly related contents of said plurality of files,
d) storing said profile in a first addressable memory location of said user computer,
e) transferring the information from said first addressable memory location to a server,
f) statistically analyzing said information from said first addressable memory location by said server to provide links to related information stored at said server,
g) compiling by said sever said related information into a second addressable memory location,
h) transferring by said server said related information from said second addressable file to said user computer,
i) updating said digital medium with said related information from said second addressable memory location.

7. The method of claim 6 wherein said updating is updating a computer disk (CD) at said user computer.

8. The method of claim 6 wherein said updating is updating an insertable magnetic disk at said user computer.

9. The method of claim 6 wherein said updating is updating a hard disk at said user computer.

10. The method of claim 6 wherein said updating is updating a user identified file at said server.
